(19) United States
(12) Patent Application Publication
(10) Pub. No.: US 2007/0121147 A1
(43) Pub. Date: May 31, 2007

(54) Systems and methods for sending scan or print jobs to multiple network destinations

(76) Inventors: Fatima Corona, Long Beach, CA (US); Walter Filbrich, Manhattan Beach, CA (US); Brent Richtsmeier, Laguna Niguel, CA (US); Hoijung Chung, Seoul (KR); Yoshio Wachi, Seoul City (KR); Jaekyung Cho, Suwon City (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/290,160

(22) Filed: Nov. 30, 2005

(51) Int. Cl. G06F 3/12

(52) U.S. Cl. 358/1.15; 358/402

(57) ABSTRACT

A network system for sending a scan and/or print job to multiple network destinations based on a single request. In one example, ajob distribution server module receives a scan or print job request from a computer system or a peripheral device, such as a multi-function peripheral (MFP) device. The request may include image data to be sent to multiple network destinations, such as, for example, printers, fax machines, computers, email addresses and the like. The server module formats and sends the data to each of the network destinations, which may process the job at substantially the same time. In certain embodiments, the server module provides the user with a graphical interface for selecting network destinations to be associated with a particular virtual port or virtual printer. Furthermore, embodiments of the system allow for sending of scan jobs directly from the peripheral device.

### BACKGROUND OF THE INVENTION

1. Field of the Invention

This invention relates to the distribution of electronic data, and more particularly, to systems and methods for communicating scan or print job data.

2. Description of the Related Technology

The distribution of digital information has dramatically increased over recent years. Users often employ computers and/or multi-function peripheral (MFP) devices to scan and/or print documents to a selected network destination, such as a printer, a fax machine or the like. Not only may the network destination be located in the office where the scan or print job originated, but the network destination may also be remote from the originating office, such as, for example, an email or facsimile address.

To meet the increasing demand for digital information distribution, some systems have attempted to integrate paperwork into electronic workflows by reducing the multiple steps traditionally involved in sending a document. For example, certain systems allow a user to send a document to a facsimile recipient directly from a scan bed, such as from a MFP device. Generally, if a user wants to scan and send a document to more than one destination, the user scans the document and sends it to a first location and then scans the document again to send it to the second location. These scanning and sending steps are generally repeated for each destination entity intended to receive the document.

Other software programs provide for printing to multiple printers that are attached directly to a common network and that each have TCP/IP support. Such software programs, however, also have their drawbacks. For example, each printer must be the same model or understand a common printer language (e.g., PDL or Postscript). Furthermore, these software programs are generally limited to use with a Windows-based computer system and/or are limited by the printer drivers present on the host computer.

### SUMMARY OF CERTAIN INVENTIVE ASPECTS OF THE INVENTION

In view of the foregoing, a need exists for systems and methods that allow for communicating a scan or a print job to multiple network destinations, which may include different types of network entities. Furthermore, a need exists for systems and methods for sending a scan job. directly from a scanning device, such as an MFP, to a plurality of network destinations.

In one embodiment, a method is disclosed for communicating a copy of a scan or print job to a plurality of network destinations. The method comprises receiving a single request to send image data of a scan job and/or a print job to a plurality of network destinations and determining a first network destination and a second network destination associated with the request, wherein each of the network destinations is capable of receiving the scan job and/or print job. The method further comprises converting the image data into a first image format for transmission to the first network destination and converting the image data into a second image format for transmission to the second network destination, wherein the second image format is different than the first image format. The method also comprises transmitting the image data in the first image format to the first network destination and transmitting the image data in the second image format to the second network destination.

In another embodiment, a system is disclosed for distributing a scan or print job to a plurality of network destinations. The system comprises a processor and a memory configured to store data associating a plurality of network destinations with a destination port. The system further comprises a server module configured to execute on the processor, the server module configured to receive a request associated with the destination port to send image data of at least one scan job and/or print job, wherein the server module is further configured to convert the image data into a first image format for transmission to a first network destination of the plurality of network destinations. The server module is further configured to convert the image data into a second image format for transmission to a second network destination of the plurality of network destinations, the second image format being different than the first image format.

In another embodiment, a machine loadable software program for a processor is disclosed for distributing within a network system a scan job or a print job received from a MFP device. The software program comprises first computer instructions for determining a first network destination and a second network destination associated with a single request to perform a scan job and/or a print job; second computer instructions for converting image data associated with the single request into a first image format for transmission to the first network destination; third computer instructions for converting the image data into a second image format for transmission to the second network destination, wherein the second image format is different than the first image format; and fourth computer instructions for transmitting the image data in the first image format to the first network destination and transmitting the image data in the second image format to the second network destination.

In another embodiment, a system is disclosed for communicating a scan or print job within a network. The system comprises means for receiving a request to send image data of a scan job and/or a print job to a plurality of network destinations and means for determining a first network destination and a second network destination associated with the request, wherein each of the network destinations is capable of receiving the scan job and/or the print job. The system further comprises means for converting the image data into a first format for transmission to the first network destination and for converting the image data into a second format for transmission to the second network destination, wherein the second format is different than the first format. In addition, the system comprises means for transmitting the image data in the first format to the first network destination and for transmitting the image data in the second format to the second network destination.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 illustrates a network system for sending a print or a scan job to a plurality of network destinations, according to certain embodiments of the invention.

FIG. 2 illustrates an exemplary flowchart of a virtual printer setup process usable with the network system of FIG. 1.

FIG. 3 illustrates an exemplary graphical user interface for prompting user selection of network destinations for a virtual port.

FIG. 4 illustrates an exemplary input window for prompting user selections or input with respect to facsimile destinations.

FIG. 5 illustrates an exemplary flowchart of a print or scan job distribution process usable by the network system of FIG. 1.

### DETAILED DESCRIPTION OF CERTAIN EMBODIMENTS OF THE INVENTION

The features of the system and method will now be described with reference to the drawings summarized above. The drawings, associated descriptions, and specific implementation are provided to illustrate embodiments of the invention and not to limit the scope of the disclosure.

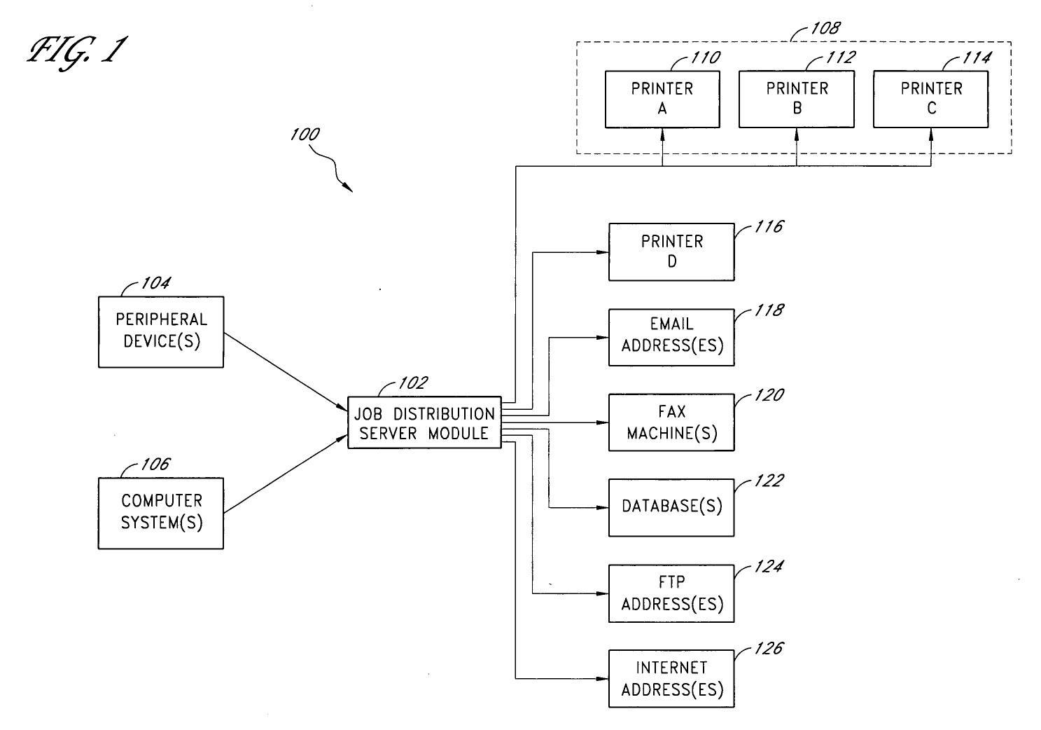

FIG. 1 illustrates a network system 100 for sending a print job or a scan job to a plurality of network destinations, according to certain embodiments of the invention. As illustrated, the system 100 includes a job distribution server module 102 in communication with at least one peripheral device 104 and at least one computer system 106. For example, the server module 102 may communicate with the peripheral device 104 and/or the computer system 106 through a wired or wireless network through a public or proprietary communication protocol.

In certain embodiments, the server module 102 receives a scan or print job request and distributes the job to a plurality of network destinations. For example, the server module 102 may receive a print request from the computer system 106, wherein a print job is to be sent to a plurality of network destinations, including network destinations having different printer drivers and/or using different printer languages. In certain embodiments, the server module 102 formats the print job data according to the requirements of each network destination and then sends the print job data for concurrent or substantially concurrent printing at the plurality of network destinations.

The phrase “network destination” as used herein is a broad term and is used in its ordinary sense and includes, without limitation, any device, system, location, entity or address capable of receiving a scan job and/or a print job. For example, a network destination may include a printer capable of receiving electronic data and printing a document reflecting the data. A network destination may also include a device capable of graphically displaying and/or storing the electronic data. In certain embodiments, a scan job will generally have a larger number of available network destinations than a print job.

In certain embodiments, the job distribution server module 102 comprises one or more software programs executed on a server computer having one or more processors. For example, the processor may have a configuration based on Intel Corporation's family of microprocessors, such as the Pentium family. In certain embodiments, the processor is implemented with a variety of computer platforms using a single chip or multi-chip microprocessors, digital signal processors, embedded microprocessors, microcontrollers, etc. In other embodiments, the processor is implemented with a wide range of operating systems such as Unix, Linux, Red Hat, Caldera, Debian, Mandrake, Slackware, TurboLinux, SuSE, Microsoft DOS, Microsoft Windows 2000/9×/ME/XP, Macintosh OS, OS/2 and the like.

Although described with reference to particular embodiments, the job distribution server module 102 may comprise logic embodied in hardware or firmware and/or comprise a collection of software instructions written in a programming language, such as, for example C++. A software module may be compiled and linked into an executable program, installed in a dynamic link library, or may be written in an interpretive language such as BASIC. It will be appreciated that software modules may be callable from other modules or from themselves, and/or may be invoked in response to detected events or interrupts. Software instructions may be embedded in firmware, such as an EPROM or EEPROM. It will be further appreciated that hardware modules may be comprised of connected logic units, such as gates and flip-flops, and/or may be comprised of programmable units, such as programmable gate arrays or processors.

It is also contemplated that components of the server module 102 may be integrated in different forms. For example, the server module 102 may include components that can be separated into several subcomponents or that can be separated into more devices or sets of software code that reside at different locations and that communicate with each other, such as through a wired or wireless network.

The job distribution server module 102 may be further configured to download configuration options associated with the computer system 106 and/or the peripheral device 104. For example, the server module 102 may allow an administrator to use the peripheral device 104 to interface with the server module 102 to configure the peripheral device 104.

In certain embodiments, the peripheral device 104 comprises a device capable of scanning a document to convert the document into an electronic format. In certain preferred embodiments, the peripheral device 104 advantageously comprises a MFP device, which includes a single device configured to perform multiple functions. These functions may include scanning, copying, printing, faxing, combinations of the same and the like. For example, the MFP device may print in black and white or in color, and/or the MFP device may scan in color and/or black and white. The details of the inner workings of scanning/printing peripheral devices are various and well known and will not be further described.

In certain embodiments, the peripheral device 104 is further capable of sending a print job to at least one network destination, such as, for example, an MFP device, a printer or a plurality of network printers. In such embodiments, the peripheral device 104 may store information associated with printing to a variety of destination entities in communication with the peripheral device 104. For example, the peripheral device 104 may download print information directly from one or more network destinations or from the server module 102. In certain embodiments, this print information allows the peripheral device 104 to communicate data to one or more of the network destinations. For example, the print information may include the printer or printer group name, the location of the printer, the printer language, the printer supports, information regarding whether the printer has an accessible driver, combinations of the same or the like.

In certain embodiments, the peripheral device 104 advantageously converts printing data (e.g., scanned document) to a specific language, and sends the converted data to the server module 102, where at least one printer driver of selected network destinations are located. In such embodiments, the server module 102 instructs the printer drivers to convert the received data to a particular printer language(s) for the selected network destination(s), and sends the data to the network destination(s). In the above embodiments, with a user's single print request for a document (single scanning and sending), the document can be printed at multiple selected network destinations.

In certain embodiments, the peripheral device 104 may download print information from the server module 102 or an external computing device. In still other embodiments, information can be generated at the peripheral device 104.

The computer system 106 comprises any system capable of processing input to output a print request. In certain embodiments, the computer system 106 comprises a personal computer, such as, for example, a desktop, a laptop or a palmtop. In yet other embodiments, the computer system 106 comprises a mobile phone, other portable communication devices such as a hand-held PC, a wallet PC or a personal digital assistant (PDA), a computer workstation, a local area network of individual computers, a kiosk, a point-of-sale device, an interactive wireless communications device, an interactive television, a transponder, combinations of the same or the like.

In certain embodiments, at least a portion of the job distribution server module 102 resides or is executed on the computer system 106. For example, the server module 102 may comprise executable code that is stored in the memory of the computer system 106.

With continued reference to FIG. 1, the illustrated job distribution server module 102 further communicates with a plurality of network destinations capable of receiving a scan job and/or a print job. As shown, the network destinations of the network system 100 include a printer group 108 (shown as including Printer A 110, Printer B 112 and Printer C 114) and a single printer 114 (shown as Printer D). One or more of these printers may include, for example, a MFP device or may be associated with an email address such that the printer automatically prints an attachment of a message sent to the email address.

FIG. 1 further illustrates the network destinations as including one or more email addresses 118, one or more fax machines 120, one or more databases 122, one or more file transfer protocol (FTP) addresses 124, and one or more Internet addresses 126.

Although described with reference to particular embodiments, the network system 100 may include more or fewer devices and/or network destinations than are illustrated in FIG. 1. For example, the network system 100 may function without either the peripheral device 104 or the computer system 106. In certain other embodiments, the network destinations may further include a copier, a workstation, a personal computer, combinations of the same or the like, in addition to, or in place of, any of the illustrated network destinations.

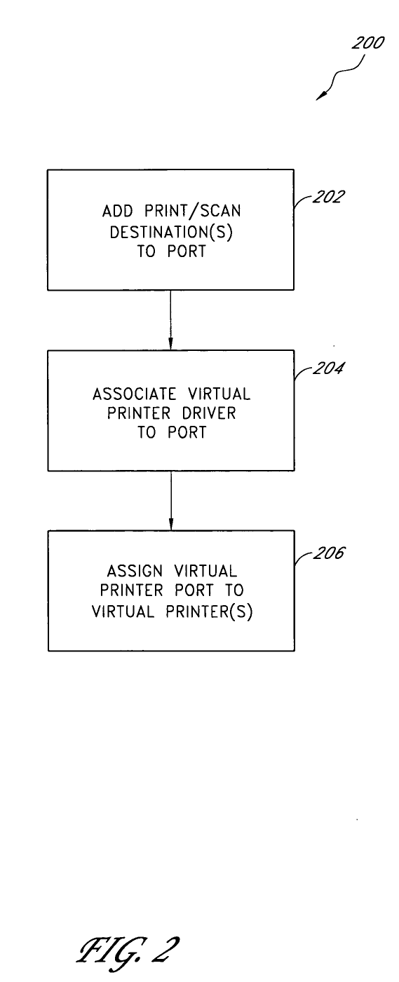

As previously described, the network system 100 advantageously allows a user to send a scan and/or print job to multiple destinations through a single user request and/or at substantially the same time. FIG. 2 illustrates an exemplary flowchart of a virtual printer setup process 200 usable with the network system 100 of FIG. 1. In particular, the setup process 200 allows the user to add network destinations to virtual printer ports in, or associated with, the server module 102. For exemplary purposes, the setup process 200 will be described herein with reference to the components of the network system 100 illustrated in FIG. 1.

As shown, the setup process 200 begins with block 202, wherein the user adds one or more network destinations to a destination port. In certain embodiments, the user may modify network destination assignments with an existing destination port, and/or the user may have the option of creating a new destination port. If a destination port has not yet been created, the user may be prompted to create and/or name a new destination port.

After network destinations have been added to the destination port, a virtual printer driver is assigned to the destination port, which is shown in block 204. In certain embodiments, the virtual printer driver is used to format data to be sent to the server module 102. For example, the virtual printer driver may use a generic format to format the data. Such an embodiment advantageously allows for the transportation of data without having to first convert the data until it reaches the server module 102. The server module 102 may then convert the data to a particular format, such as, for example, Printer Control Language or Postscript. In certain embodiments, the generic format is particularly useful with virtual printer drivers called from within an application, such as, for example, Microsoft Word.

Once the virtual printer driver is assigned to a destination port, the setup process 200 proceeds with block 206. At block 206, a printer to be used when sending a print/scan job is assigned to the port designated in blocks 202 and 204. In certain embodiments, the user creates a virtual printer, such as, for example, through the Add Printer Wizard provided in Windows-based systems. In other embodiments, the user assigns an already existing virtual printer to the designated port. In yet other embodiments, the virtual printer may be automatically created and/or assigned by the server module 102 and/or by the computer system 106.

The blocks described with respect to the process 200 illustrated in FIG. 2 are not limited to any particular sequence, and the blocks relating thereto can be performed in other sequences that are appropriate. For example, described blocks may be performed in an order other than that specifically disclosed or may be executed in parallel, or multiple blocks may be combined in a single block.

It will be appreciated that not all blocks of the setup process 200 need to be executed or additional blocks may be included without departing from the scope of the disclosure. For instance, the setup process 200 may include an additional block wherein the user is asked to confirm the existence of drivers for network destinations (e.g., printers or group of printers) added to a port during block 202.

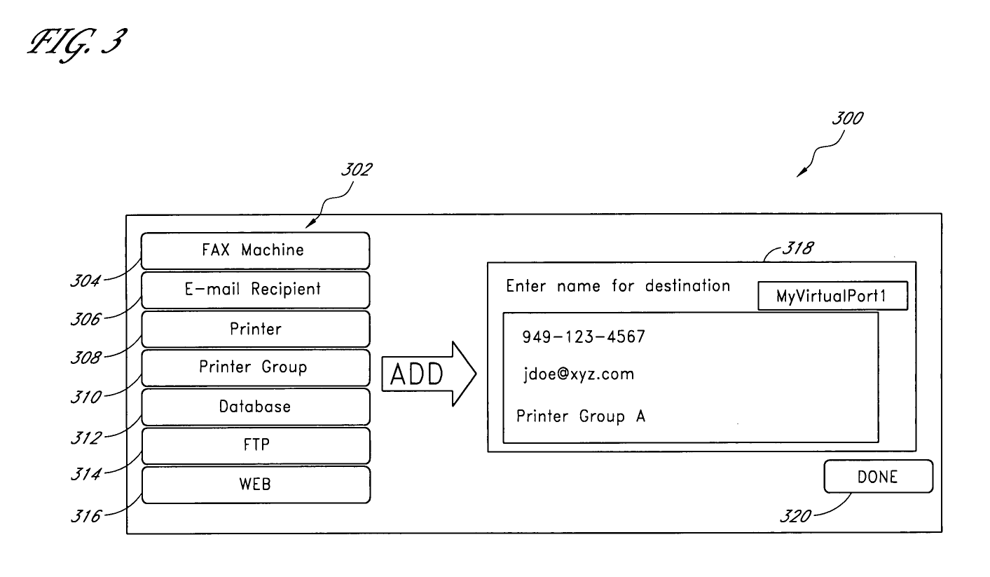

FIG. 3 illustrates an exemplary graphical user interface 300 for prompting user selections of network destinations. In particular, the interface 300 of FIG. 3 is associated with a particular virtual port entitled “MyVirtualPort1.” In certain embodiments, a user is provided with or may access the interface 300 during block 202 of the setup process 200 depicted in FIG. 2. For instance, the interface 300 may be presented to the user when the user inputs information regarding the creation of a print/scan destination port such as by, for example, selecting a button, a link or the like to create the destination port.

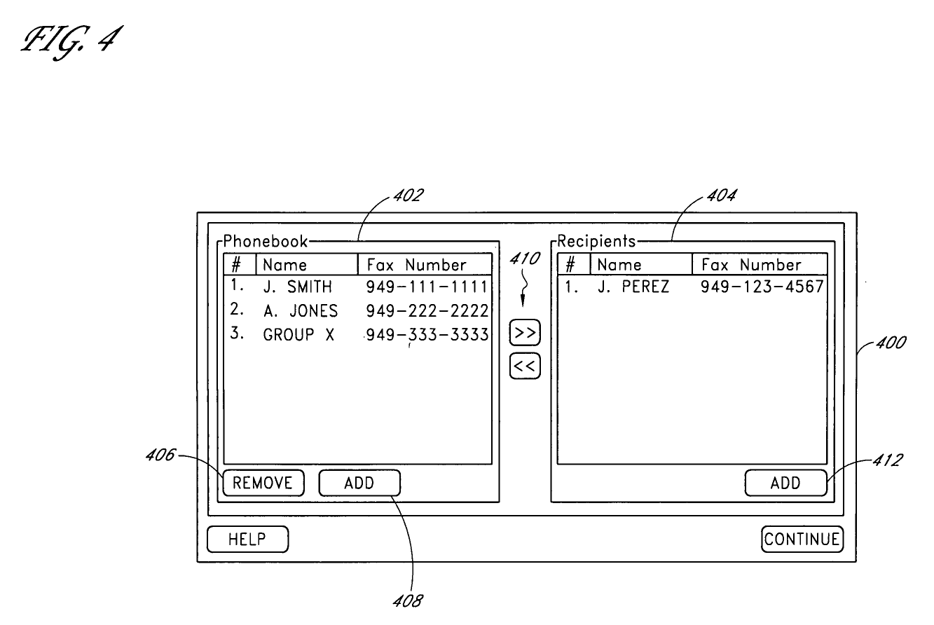

As illustrated, the interface 300 includes a plurality of destination group buttons 302 that a user may access to revise the list of network destinations associated with the destination port. For example, the illustrated destination group buttons 302 include a fax machine button 304, an email recipient button 306, a printer button 308, a printer group button 310, a database button 312, an FTP button 314 and a WEB button 316. In certain embodiments, when the user selects one of the destination group buttons 302, another interface is presented to the user whereby the user may input additional information regarding the particular network destination to be added to the destination port. An example of such a second interface is described in more detail later with reference to FIG. 4.

As shown, the interface 300 further includes an assigned destinations box 318 listing the particular network destinations that have been added to the virtual port MyVirtualPort1. In particular, the fax number 949-123-4567, the email address jdoe@xyz.com and Printer Group A have been added to the assigned destinations box 318, thus enabling a user to send, for example, a scan job to all three destinations in a single scan request when using the virtual printer assigned to MyVirtualPort1. Also shown is a done button 320 that the user may select when he or she has completed adding network destinations to the particular port.

In certain embodiments, the user interface 300 is provided on a display of the computer system 106. In other embodiments, the interface 300, or variations thereof, may be displayed on a computing device having the server module 102 or on the peripheral device 104.

In other embodiments, other forms or styles of interfaces may be used. For example, the interface may include multiple windows, a table, an Internet or intranet page, hypertext links, a touch sensor, combinations of the same or the like. Furthermore, the interface 300 may include more or fewer destination group buttons 302 than those depicted in FIG. 3. For example, the interface 300 may include a button for selecting at least one computer or workstation as a network destination.

FIG. 4 illustrates an exemplary user input window 400 for prompting user selections or input with respect to facsimile destinations. For example, in certain embodiments, the input window 400 is displayed when the user selects the fax machine button 304 on the interface 300 of FIG. 3. In general, through the input window 400 the user may add and/or delete facsimile destinations to or from the associated destination port.

As shown, the input window 400 includes a phonebook window 402 and a recipients window 404. The phonebook window 402 includes a list of entries having names (e.g., individual names, group names, destination names and the like) and/or fax numbers that are available for addition to the recipients window 404. The recipients window 404 includes the particular network destinations currently assigned to the associated port.

Further illustrated are a remove button 406, which allows a user to remove an entry from the phonebook window 402, and an add entry button 408, which allows a user to add an entry to the phonebook window 402. Selection buttons 410 may be used to move an entry from the phonebook window 402 to the recipients window 404 or vice-versa. An add destination button 412 allows a user to directly add an entry to the recipients window 404, which entry may or may not be listed in the phonebook window 402.

In certain embodiments of the invention, similar windows may be used with each of the destination groups shown in the interface 300 of FIG. 3. In yet other embodiments, other types of interfaces for receiving and/or displaying information may be used to select the particular network destinations for an associated port. For example, a user may use multiple windows, a table, an Internet or intranet page, hypertext links, a touch sensor, combinations of the same or the like, to select particular network destinations.

For example, an input window for adding printers to a selected destination port may allow a user to select the appropriate printer by using the printer's Internet Protocol (IP) address, host name and/or Uniform Resource Locator (URL). The hostname of a printer is a name of the printer which is assigned a certain IP address. The hostname and the corresponding IP address of a printer are oftentimes used interchangeably to refer to the same network device. Such an input window may also allow a user to create a group of printers.

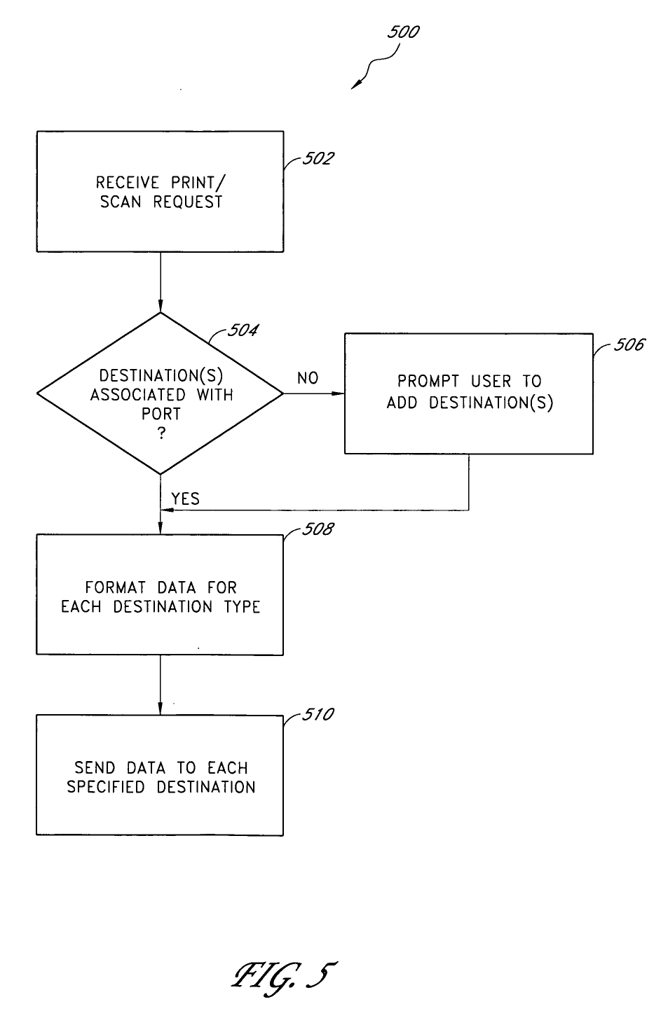

FIG. 5 illustrates an exemplary flowchart of a print or scan job distribution process 500, according to certain embodiments of the invention. In certain embodiments, the distribution process 500 allows for a print job or a scan job to be distributed to a plurality of network destinations in a single user request. For exemplary purposes, the distribution process 500 will be described herein with reference to the components of the network system 100 depicted in FIG. 1.

The distribution process 500 begins at block 502, wherein the network system 100 receives a print or a scan request. In certain embodiments, the print or scan request is received by the server module 102 from the peripheral device 104 or the computer system 106. For example, the print or scan request may comprise data representing the document to be sent to one or more network destinations. In certain embodiments, the received data has been formatted using the virtual printer driver described previously with respect to block 204 of the setup process 200.

The print or scan request may also identify the virtual printer selected for the request, the printer either having been selected by the user or selected automatically. For example, for a print request, a user may decide to send a print job by selecting a “PRINT” option from a drop-down menu, or by selecting a related icon, within a particular application (e.g., Microsoft Word, Notepad, Adobe Acrobat and the like). As part of the print request, the user also selects a printer to perform the print job. For example, in certain embodiments, when the user selects a print option, a pop-up window is displayed, from which the user may select the printer to perform the print job. In certain embodiments, the user may advantageously select a virtual printer created by the server module 102, such as described in more detail with respect to block 206 of the setup process 200 illustrated in FIG. 2.

With respect to a scan job, in certain embodiments, the user may select a virtual printer by using the interface or control panel of the peripheral device 104. For example, the user may select a virtual printer through the use of a touch screen of the peripheral device. In such embodiments, the peripheral device 104 may have previously downloaded information from the server module 102. Such downloaded information may include data regarding the virtual ports and/or the network destinations available in the network system 100. In other embodiments, the user may select the virtual printer for the peripheral device 104 through the use of the computer system 106 or another external computing device.

After the server module 102 receives the print or scan request, the process 500 proceeds with block 504. At block 504, the server module 102 determines if one or more network destinations have been associated with the port assigned to the selected virtual printer (such as may be done during the setup process 200). If no network destinations have been assigned, the process 500 proceeds with block 506, wherein the server module 102 provides a user interface that prompts the user to enter one or more network destinations for the print or scan job. For example, the user interface provided during block 506 may be similar to the user interface 300 depicted in FIG. 3. In certain embodiments, this user interface may be provided at the server module 102, the peripheral device 104 or the computer system 106.

Once the user has entered at least one network destination, or if one or more network destinations had previously been associated with the particular port, the process 500 proceeds with block 508. At block 508, the server module 102 formats the data for the print job or scan job for each network destination type associated with the port assigned to the selected printer. Such formats may include, but are not limited to, one or more of the following formats or file types: Postscript, Printer Control Language (PCL), Page Description Language (PDL), Portable Document Format (PDF), JPG, Tagged Image File (TIF), MTIFF, Graphic Interchange Format (GIF), Multipurpose Internet Mail Extensions (MIME), Hyper Text Markup Language (HTML), Rich text Format (RTF), Bitmap (BMP), and the like.

In certain embodiments, the server module 102 determines whether each network destination has an accessible driver or is using its own driver. For network destinations that do not use their own drivers, the server module 102 converts the scan job or print job document to a particular language (e.g., PDL or PostScript) supported by the individual network destination, as appropriate.

In certain embodiments in which the network destination has its own accessible printer driver(s), the server module 102 forwards the scan or print job to the network destination and/or requests that the printer driver(s) convert the scanned data to a supported printer language of the network destination.

In certain embodiments, the printer drivers are located in the computing device on which the server module 102 is loaded. In other embodiments, the printer drivers can be installed in another computer (not shown) which is in data communication with the server module 102 and/or the network destinations.

Once the data is properly formatted, the server module 102 sends the formatted data to the appropriate specified network destinations, as is shown in block 510. In certain embodiments, at least two of the network destinations are capable of processing the scan or print job at substantially the same time. For example, an email recipient may receive a PDF copy of a scan job at substantially the same time as a printer is printing a paper copy of the scan job.

As described above, embodiments of the present invention advantageously allow for the sending of print jobs and/or scan jobs to multiple destinations with a single user request. Certain embodiments also advantageously provide for the sending of print or scan jobs directly from a peripheral device, such as an MFP without the need for the user to make multiple requests.

In certain embodiments of the invention wherein the user decides to send a scan job, the scan request may be performed in a variety of alternative methods. For example, a user may initiate a scan request from the server module 102 and may then place the image/document to be scanned on the scan bed or in a document feeder of the peripheral device 104. The server module 102 then receives the image and requests the user to select and/or input at least one network destination to receive the scanned image/document.

In other embodiments, the user may initiate the scan request from the peripheral device 104, such as an MFP, and select a folder on a computing device that is monitored by the server module 102. For example, the peripheral device 102 may be configured to send the scanned image/document to a folder on the computer system 106 or on a computing device that also includes the server module 102. The server module 102 may then retrieve the scanned image/document from the specific folder and/or request the user to select and/or input at least one network destination to receive the scanned image/document.

In yet other embodiments, the user may initiate the scan request from the peripheral device 104 and may scan the image/document directly to the server module 102. Upon receiving the scanned image/document, the server module 102 may automatically display a user interface that requests the user to select and/or input at least one network destination to receive the scanned image/document. For example, the user interface may be displayed at the peripheral device 104, the computer system 106 or a computer system having the server module 102. In embodiments where the network destinations are assigned during a setup process, such as the setup process 200 of FIG. 2, and downloaded to the peripheral device 104, the user may select one or more network destinations at the interface or control panel of the peripheral device 104 without using the user interface of the server module 102.

While certain embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A method of communicating a copy of a scan or print job to a plurality of network destinations, the method comprising:
receiving a single request to send image data of at least one of a scan job and a print job to a plurality of network destinations;
determining a first network destination and a second network destination associated with the request, wherein each of the first and second network destinations is capable of receiving the at least one of the scan job and the print job;
converting the image data into a first image format for transmission to the first network destination;
converting the image data into a second image format for transmission to the second network destination, wherein the second image format is different than the first image format; and
transmitting the image data in the first image format to the first network destination and transmitting the image data in the second image format to the second network destination.

2. The method of claim 1, wherein said receiving the single request comprises receiving a request from a computer system to send image data of a print job.

3. The method of claim 1, wherein said receiving the single request comprises receiving a request from a peripheral device to send image data of a scan job.

4. The method of claim 3, wherein the peripheral device is a multi-function peripheral (MFP) device.

5. The method of claim 1, wherein the first network destination comprises one of: a printer, a group of printers, an email address and a fax machine.

6. The method of claim 5, wherein the second network destination is different than the first network destination and comprises one of: a printer, a group of printers, an email address and a fax machine.

7. The method of claim 1, wherein said converting the image data into the first image format comprises converting the image data into postscript.

8. The method of claim 1, wherein said converting the image data into the first image format comprises converting the image data into page description language (PDL).

9. The method of claim 1, additionally comprising obtaining a user selection of the plurality of network destinations.

10. The method of claim 9, wherein said obtaining comprises providing a graphical user interface including available network destinations capable of receiving the at least one of the scan job and the print job.

11. A system for distributing a scan or print job to a plurality of network destinations, the system comprising:
a processor;
a memory configured to store data associating a plurality of network destinations with a destination port; and
a server module configured to execute on the processor, the server module configured to receive a request associated with the destination port to send image data of at least one of a scan job and a print job,
and wherein the server module is further configured to convert the image data into a first image format for transmission to a first network destination of the plurality of network destinations, and wherein the server module is further configured to convert the image data into a second image format for transmission to a second network destination of the plurality of network destinations, the second image format being different than the first image format.

12. The system of claim 11, wherein the first network destination comprises one of: a printer, a group of printers, an email address and a fax machine.

13. The system of claim 12, wherein the second network destination is different than the first network destination and comprises one of: a printer, a group of printers, an email address and a fax machine.

14. The system of claim 11, wherein the first image format comprises one of: postscript, page description language (PDL), printer control language (PCL), portable document format (PDF) and a JPG file format.

15. The system of claim 11, wherein the image data comprises data received from a multi-function peripheral (MFP) device.

16. The system of claim 11, wherein the server module is further configured to determine if each of the plurality of network destinations has its own accessible printer driver.

17. A machine loadable software program for a processor for distributing within a network system a scan job or a print job received from a multi-function peripheral (MFP) device, the software program comprising:
first computer instructions for determining a first network destination and a second network destination associated with a single request to perform at least one of a scan job and a print job;
second computer instructions for converting image data associated with the single request into a first image format for transmission to the first network destination;
third computer instructions for converting the image data into a second image format for transmission to the second network destination, wherein the second image format is different than the first image format; and
fourth computer instructions for transmitting the image data in the first image format to the first network destination and transmitting the image data in the second image format to the second network destination.

18. The software program of claim 17, wherein the first network destination comprises a group of printers.

19. A system for communicating a scan or print job within a network, the system comprising:
means for receiving a request to send image data of at least one of a scan job and a print job to a plurality of network destinations;
means for determining a first network destination and a second network destination associated with the request, wherein each of the first and second network destinations is capable of receiving the at least one of the scan job and the print job;
means for converting the image data into a first format for transmission to the first network destination and for converting the image data into a second format for transmission to the second network destination, wherein the second format is different than the first format; and
means for transmitting the image data in the first format to the first network destination and for transmitting the image data in the second format to the second network destination.

20. The system of claim 19, wherein the first format and the second format are printer formats.
